(19) United States
(12) Patent Application Publication
(10) Pub. No.: US 2026/0320947 A1
(43) Pub. Date: Oct. 15, 2026

(54) VIRTUAL OBJECT SETTING METHOD AND APPARATUS, MEDIUM, ELECTRONIC DEVICE, AND PROGRAM PRODUCT

(71) Applicant: Beijing Zitiao Network Technology Co., Ltd., Beijing (CN)

(72) Inventors: Yiyang CHEN, Beijing (CN); Kun CAO, Beijing (CN)

(21) Appl. No.: 19/484,871

(22) PCT Filed: Jul. 25, 2024
(86) PCT No.: PCT/CN2024/107609

§ 371 Date: Nov. 16, 2025

(30) Foreign Application Priority Data
Mar. 25, 2024 (CN) 202410346505.7

(51) Int. Cl. G06T 19/20; A63F 13/52; A63F 13/60

(52) U.S. Cl. CPC G06T 19/20; A63F 13/52; A63F 13/60

(57) ABSTRACT

The present disclosure relates to a virtual object setting method, a medium, and an electronic device. According to the method, a virtual scene is displayed; an object setting region is determined in the virtual scene based on a locked range and a first initial editing point that are selected in the virtual scene, where the locked range includes an axial range and a planar range; in response to a movement operation for a first virtual object in the virtual scene, the first virtual object is controlled to move in the object setting region; and the first virtual object is set at a target editing point in the object setting region in response to a setting instruction.

The present application claims priority to Chinese Patent Application No. 202410346505.7, filed on Mar. 25, 2024, which is incorporated herein by reference in its entirety as a part of the present application.

### TECHNICAL FIELD

Embodiments of the present disclosure relate to a virtual object setting method, a virtual object setting apparatus, a medium, an electronic device, and a program product.

### BACKGROUND

In setting an object in a three-dimensional space, there is a tricky problem: how to pinpoint a position pointed to by a user and draw a three-dimensional shape in the three-dimensional space. In the related art, a user often needs to construct continuous auxiliary lines to assist in locating, and then delete the auxiliary lines after the construction is completed. However, this method is highly inefficient, and the object cannot be quickly set in the three-dimensional space.

### SUMMARY

The summary is provided to give a brief overview of concepts, which will be described in detail in the following detailed description of embodiments. The summary is neither intended to identify key or necessary features of the claimed technical solutions, nor is it intended to be used to limit the scope of the claimed technical solutions.

According to a first aspect, the present disclosure provides a virtual object setting method, including:
displaying a virtual scene;
determining, in the virtual scene, an object setting region based on a locked range and a first initial editing point that are selected in the virtual scene, where the locked range includes an axial range and a planar range;
controlling, in response to a movement operation for a first virtual object in the virtual scene, the first virtual object to move in the object setting region; and
setting the first virtual object at a target editing point in the object setting region in response to a setting instruction.

According to a second aspect, the present disclosure provides a virtual object setting apparatus, including:
a display module configured to display a virtual scene;
a determining module configured to determine, in the virtual scene, an object setting region based on a locked range and a first initial editing point that are selected in the virtual scene, where the locked range includes an axial range and a planar range;
a control module configured to control, in response to a movement operation for a first virtual object in the virtual scene, the first virtual object to move in the object setting region;
a setting module configured to set the first virtual object at a target editing point in the object setting region in response to a setting instruction.

According to a third aspect, the present disclosure provides a computer-readable medium, a computer program is stored on the computer-readable medium, where the program, when executed by a processing apparatus, causes the steps of the method according to the first aspect to be implemented.

According to a fourth aspect, the present disclosure provides an electronic device, including:
a storage apparatus, a computer program is stored on the storage apparatus; and
a processing apparatus configured to execute the computer program in the storage apparatus to implement the steps of the method according to the first aspect.

According to a fifth aspect, the present disclosure provides a computer program product including a computer program. The computer program, when executed by a processor, causes the steps of the method according to the first aspect to be implemented.

The other features and advantages of the present disclosure will be described in detail in the following Detailed Description section.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flowchart of a virtual object setting method according to some embodiments;

FIG. 2 is a schematic diagram of a first virtual object according to some embodiments;

FIG. 3 is a schematic diagram of an object setting region according to some embodiments;

FIG. 4 is a flowchart of determining a first initial editing point according to some embodiments;

FIG. 5 is a schematic diagram of a first initial editing point according to some embodiments;

FIG. 6 is a schematic diagram of an object setting region shown according to some embodiments;

FIG. 7 is a detailed flowchart of step 140 shown in FIG. 1;

FIG. 8 is a flowchart of determining a locked range according to an exemplary embodiment;

FIG. 9 is a schematic structural diagram of a virtual object setting apparatus according to some embodiments; and

FIG. 10 is a schematic structural diagram of an electronic device according to some embodiments.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between a plurality of apparatuses in the implementation modes of the present disclosure are used for illustrative purposes only, and are not used to limit the scope of these messages or information.

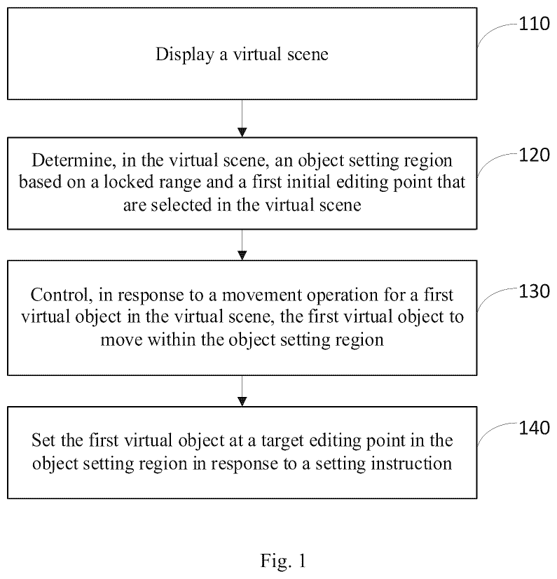

FIG. 1 is a flowchart of a virtual object setting method according to some embodiments. As shown in FIG. 1, an embodiment of the present disclosure provides a virtual object setting method. The method may be performed by an electronic device, specifically by a virtual object setting apparatus. The apparatus may be implemented in the form of software and/or hardware and configured in an electronic device. As shown in FIG. 1, the method may include the following steps.

In step 110, a virtual scene is displayed.

The virtual scene herein may be a three-dimensional virtual scene, such as a three-dimensional game scene or a virtual reality scene. It should be understood that the virtual scene displayed by the electronic device may be an image obtained by a virtual camera in the virtual scene.

A virtual camera, which is a technique that simulates motion and angle-of-view management of a real camera, is responsible for determining content and an observation angle that a player sees in the virtual scene. The virtual camera may dynamically adjust parameters such as a position, a direction, a focal length, and a field-of-view range of the camera, to provide the best gaming visual experience. That is, the virtual camera is a core component for controlling the visual perception of a player in game development, which greatly affects the visual storytelling and play experience of a game. For example, if a user moves the orientation of the virtual camera from left to right, it means that the user is going to look toward the right side of the virtual scene, and the presented image content includes content on the right side of the virtual scene.

In step 120, an object setting region is determined in the virtual scene based on a locked range and a first initial editing point that are selected in the virtual scene.

The locked range may be a range selected by the user in the virtual scene. The locked range may include an axial range and a planar range. That is, the locked range may be an axial range in the virtual scene or may be a planar range in the virtual scene. It should be understood that the locked range means that a first virtual object will be fixed within a region corresponding to the locked range in the virtual scene for movement and drawing.

For example, the virtual scene may be constructed through a first coordinate axis, a second coordinate axis, and a third coordinate axis. The first coordinate axis, the second coordinate axis, and the third coordinate axis may be an X axis, a Y axis, and a Z axis, respectively. If the user selects the X axis from among the X axis, the Y axis, and the Z axis through a lock operation, the X axis is the locked range. That is, the first virtual object may be fixed on the X axis of the virtual scene for movement. If the user selects the X axis and the Z axis from among the X axis, the Y axis, and the Z axis through a lock operation, a plane formed by the X axis and the Z axis is the locked range. That is, the first virtual object may be fixed within the plane formed by the X axis and the Z axis for movement and drawing.

The first initial editing point is a point selected by the user in the virtual scene. For example, when the user needs to set a virtual object at a point in a virtual space, the user may select a point in the virtual scene.

For example, the first initial editing point may be determined by a cursor point displayed on a screen. Since the locked range is a general range in the virtual space, it is not possible to determine a precise range. For example, when the user selects the X axis as the locked range, numerous locked ranges of the X axis may be located in the virtual scene. When the user selects the plane formed by the X axis and the Z axis as the locked range, numerous planes formed by the X axis and the Z axis may be located in the virtual scene. Therefore, the object setting region may be determined in the virtual scene based on the locked range and the first initial editing point.

The object setting region is a range within which the first virtual object may move and draw in the virtual space. That is, the first virtual object may be fixed within a region corresponding to the object setting region in the virtual scene for movement and drawing.

It is worth noting that a first initial editing point may be located in the virtual scene by the cursor point on the screen. Then, a unique object setting region may be determined in the virtual scene based on the first initial editing point and the locked range. For example, coordinates of the first initial editing point mapped from the cursor point on the screen are (5, 5, 5). If the user selects the X axis as the locked range, in the virtual scene, the X axis that passes through the first initial editing point with the coordinates of (5, 5, 5) is the object setting region. If the user selects the plane formed by the X axis and the Z axis as the locked range, in the virtual scene, a plane that includes the first initial editing point with the coordinates of (5, 5, 5) and that is formed by the X axis and the Z axis is the object setting region.

It should be noted that in embodiments of the present disclosure, the electronic device may be a fixed terminal such as a digital TV, a desktop computer and so on, or may be a mobile terminal such as a virtual reality device, a mobile phone, a tablet computer and so on. Therefore, in embodiments of the present disclosure, the cursor point may be a cursor point of a mouse or may be a touch point on a touch screen.

In step 130, in response to a movement operation for the first virtual object in the virtual scene, the first virtual object is controlled to move within the object setting region.

The virtual object herein may be a virtual object set in the virtual scene. It should be understood that the virtual object in the present disclosure may be a block or an object of any structure, such as a staircase, a fence, a street light, a utility pole, a road, a tree and so on.

For example, the electronic device may display the first virtual object in the virtual scene in response to a scene building operation.

The scene building operation may be an operation triggered by a user to instruct to set a virtual object in the virtual scene. Through the scene building operation, the user may enable a function for setting an object in the virtual scene. It should be noted that the scene building operation may be triggered in various ways and is not limit in the present disclosure. For example, the scene building operation may be triggered by a shortcut key or by clicking a specific function button.

For example, if the electronic device has detected the scene building operation, the electronic device displays, in response to the scene building operation, a first virtual object to be set in the virtual scene. The first virtual object may be an object that is selected by the user and that needs to be set in the virtual scene. For example, when the user needs to build a house in the virtual scene, a first virtual object for building the house may be selected through the scene building operation, thereby displaying the first virtual object to be set in the virtual scene.

It is worth noting that the first virtual object to be set has not been substantiated in the virtual scene. After the user determines to set the virtual object, the first virtual object to be set may be substantiated in the virtual scene. Certainly, the user may control the first virtual object to move in the virtual scene through a mouse or a touch trajectory, thereby setting the first virtual object at any position in the virtual scene.

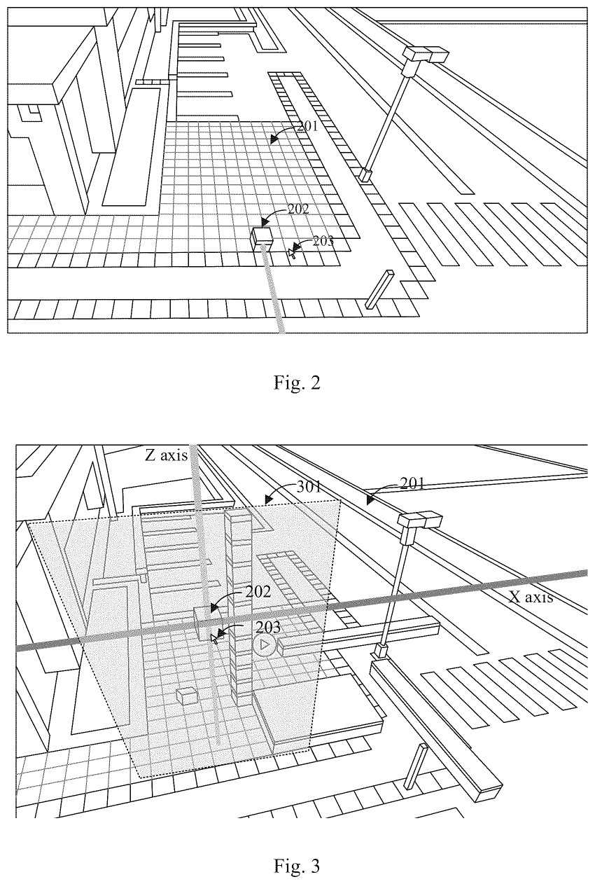

FIG. 2 is a schematic diagram of a first virtual object shown according to some embodiments. As shown in FIG. 2, the electronic device displays a first virtual object 202 in a virtual scene 201 in response to a scene building operation. A user may control the first virtual object 202 to move in the virtual scene through a cursor point 203 corresponding to a mouse.

The first virtual object is set to move following the cursor point. Correspondingly, the cursor point may move through a movement operation, thereby controlling the first virtual object to move in the object setting region.

It should be understood that no matter in which direction the user moves the cursor point, the first virtual object may be locked within the object setting region for movement, without going beyond the object setting region. That is, even if the cursor point moves freely on the screen, the first virtual object may be corrected to move within the object setting region, so that the user may perform precise localization in a three-dimensional virtual scene, and the set first virtual object may not shift due to jitter of the cursor point.

For example, when the user needs to draw a straight line on the X axis of the virtual scene, the user may select the X axis as the locked range, and the object setting region is the X axis, which passes through the first initial editing point corresponding to the cursor point, in the virtual scene.

Correspondingly, since the first virtual object is locked within the object setting region for movement, a straight line may be drawn on the X axis even if a moving trajectory of the cursor point on the screen is not a straight line.

It is worth noting that the user may move the cursor point in different ways for different scenes. For example, the cursor point may be moved by using the mouse or through the touch trajectory on the screen.

FIG. 3 is a schematic diagram of an object setting region shown according to some embodiments. As shown in FIG. 3, a first virtual object 202 is displayed in a virtual scene 201. A user may control the first virtual object 202 to move in an object setting region 301 through a cursor point 203. The object setting region 301 is constructed through the plane formed by the X axis and the Z axis. It should be understood that a size of the object setting region 301 shown in FIG. 3 is only an example and does not mean that the size of the object setting region 301 may only be the size shown in FIG. 3.

In step 140, the first virtual object is set at a target editing point in the object setting region in response to a setting instruction.

The setting instruction herein may be an instruction that is triggered by a user to instruct to set the first virtual object at the target editing point in the object setting region. The setting instruction may be triggered in different ways for different scenes. For example, if the cursor point is a cursor point of a mouse, the setting instruction may be triggered by performing a single click on the mouse.

In the moving process of the first virtual object, the user may determine to set the first virtual object at the target editing point corresponding to the object setting region by triggering the setting instruction. Then, the electronic device substantively draws a first virtual object at the target editing point.

The target editing point is a point where the cursor point is mapped onto the object setting region when the setting instruction is triggered. It should be understood that since the first virtual object is limited within the object setting region, the point where the cursor point is mapped onto the virtual scene may be corrected to be within the object setting region no matter how the cursor point moves on the screen. For example, if the cursor point is moved on the screen, the cursor point is a two-dimensional coordinate on the screen. The cursor point may be mapped into a three-dimensional virtual scene first to obtain a second initial editing point of the cursor point in the virtual scene. Then, the second initial editing point is corrected to be within a range of the object setting region based on the object setting region, to obtain three-dimensional coordinates of the target editing point. Thus, the first object is set at the three-dimensional coordinates.

As shown in FIG. 3, the user may control the first virtual object 202 to move in the object setting region 301 through the cursor point 203, to set the virtual object at a desired position. The user may set the first virtual object 202 at any position in the object setting region 301 by triggering the setting instruction.

It is worth noting that during moving the first virtual object, if the user continuously triggers the setting instruction, a plurality of first virtual objects may be drawn continuously at a plurality of consecutive target editing points. That is, a straight line made up of the first virtual objects may be drawn in the virtual scene.

It should be noted that step 130 and step 140 may be performed simultaneously. Certainly, step 130 may be performed alone. That is, the user may control the first virtual object to move within the object setting region through step 130, instead of setting the first virtual object in the virtual scene at step 140.

Thus, by displaying a virtual scene; determining, in the virtual scene, an object setting region based on a locked range and a first initial editing point that are selected in the virtual scene, where the locked range includes an axial range and a planar range; controlling, in response to a movement operation for a first virtual object in the virtual scene, the first virtual object to move in the object setting region; and setting the first virtual object at a target editing point in the object setting region in response to a setting instruction, any position can be efficiently and accurately located in the virtual scene, so that a user can be better assisted in building an object in the virtual scene, which greatly enhances a gaming experience of the user, has simple operations, and satisfies the visual intuition of the user.

In some feasible implementations, in response to switching the locked range, the cursor point may be controlled to be displayed on a first virtual object to be set.

Switching the locked range herein may mean that the user switches the locked range to another locked range. For example, the X axis is an initial locked range. If the user needs to make a drawing on the Y axis instead, the locked range needs to be switched from the X axis to the Y axis. For another example, the X axis is an initial locked range. If the user needs to make a drawing on the plane formed by the X axis and the Z axis instead, the locked range needs to be switched from the X axis to the plane formed by the X axis and the Z axis.

It should be understood that since the first virtual object may be limited within the object setting region corresponding to the locked range, the object setting region may change accordingly in response to switching the locked range. Correspondingly, the first virtual object needs to be moved into a new object setting region. In order to ensure that the first virtual object can follow the cursor point to move, in response to switching the locked range, the electronic device may control the cursor point to be displayed on the shown first virtual object to be set, to enable the first virtual object to follow the cursor point to move, without offset. Thus, the setting of virtual objects in the virtual scene is made to be more in line with visual intuition of a user.

In some embodiments, a position of the first virtual object to be set may be kept unchanged, and the cursor point may be controlled to move to a center point of the first virtual object to be set.

During the switching of the locked range, the electronic device moves the cursor point to the center point of the first virtual object. That is, in response to switching the locked range, the first virtual object to be set is not moved, but the cursor point is moved to the center point of the first virtual object, so that the cursor point and the first virtual object can keep following the movement.

For example, the X axis is an initial locked range. If the user needs to make a drawing on the plane formed by the X axis and the Z axis instead, the locked range needs to be switched from the X axis to the plane formed by the X axis and the Z axis. In this case, the position of the first virtual object is unchanged, and the cursor point is moved to the center point of the first virtual object to be set.

Based on this, by keeping the position of the first virtual object to be set unchanged and moving the cursor point, the cursor point and the first virtual object may follow the movement. This may prevent the first virtual object from jumping in the virtual scene, thus preventing a virtual object from being drawn by mistake in the virtual scene.

In some other embodiments, in response to switching the locked range, the position of the cursor point may be kept unchanged, and the first virtual object is controlled to move to the position at which the cursor point is located.

In still some other embodiments, in response to switching the locked range, if the position of the cursor point does not change, the position of the first virtual object is kept unchanged; and if the position of the cursor point changes, the first virtual object is controlled to move to the position at which the cursor point is located.

Thus, through the above implementation, the first virtual object can follow the cursor point to move, which is visually more in line with the intuition of a user and can greatly enhance the user experience.

In some feasible implementations, the object setting region may also be displayed in the virtual scene.

As shown in FIG. 3, the object setting region 301 herein is constructed by the plane formed by the X axis and the Z axis, and the object setting region 301 may be displayed in the virtual scene 201. It should be understood that the object setting region 301 may be displayed in the virtual scene 201 with a specific color. Certainly, the object setting region 301 may also be displayed in the virtual scene 201 in other ways, for example, in a shadow or line box manner.

Thus, by displaying the object setting region in the virtual scene, the user can intuitively learn the object setting region, thereby assisting the user in better setting an object in the virtual scene.

In some feasible implementations, the first initial editing point may be determined based on the cursor point displayed on the screen, where the first initial editing point is a position where the cursor point is mapped into the virtual scene.

As in the above embodiment, the first initial editing point herein is the position where the cursor point displayed on the screen is mapped into the virtual scene. It should be understood that the first initial editing point is actually a position, pointed to by a user through the cursor point, in the virtual scene. For example, if the cursor point is a cursor point of a mouse, the first initial editing point is a position that is selected by the user in the virtual scene through the cursor point of the mouse.

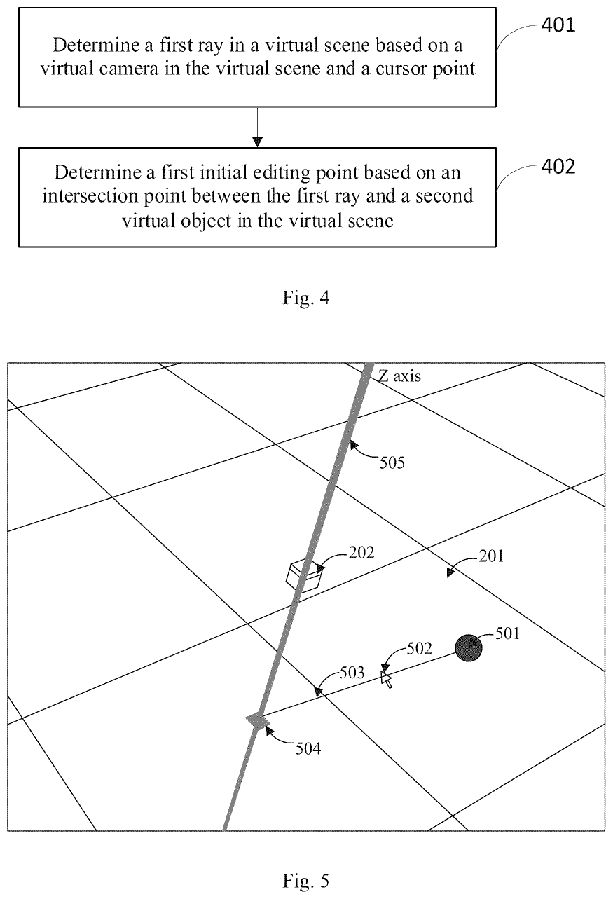

FIG. 4 is a flowchart of determining a first initial editing point according to some embodiments. As shown in FIG. 4, in some feasible implementations, the first initial editing point may be determined by the following steps:

In step 401, a first ray is determined in the virtual scene based on a virtual camera in the virtual scene and the cursor point.

Herein, three-dimensional coordinates of the virtual camera in the virtual scene may be determined, and then the first ray that includes a position of the virtual camera and a position of the cursor point is constructed in the virtual scene based on the three-dimensional coordinates of the virtual camera and two-dimensional coordinates of the cursor point on the screen.

In step 402, the first initial editing point is determined based on an intersection point between the first ray and a second virtual object in the virtual scene.

Herein, the intersection point between the first ray and the second virtual object in the virtual scene is obtained based on the first ray, and the intersection point between the first ray and the second virtual object in the virtual scene is determined as the first initial editing point.

It is worth noting that the second virtual object in the virtual scene may be a virtual object set by a user in the virtual scene, or an object that the virtual scene itself has. For example, the second virtual object may be a floor in the virtual scene.

FIG. 5 is a schematic diagram of a first initial editing point shown according to some embodiments. As shown in FIG. 5, a first ray 503 that passes through a virtual camera 501 and a cursor point 502 is constructed based on a position of the virtual camera 501 and a position of the cursor point 502. Then, an intersection point between the first ray 503 and a second virtual object in a virtual scene 202 is obtained based on the first ray 503 and the second virtual object in the virtual scene 202. Next, the intersection point is determined as a first initial editing point 504.

It is worth noting that since the virtual camera can determine image content that a player sees in the virtual scene, and an observation angle, the first initial editing point where the cursor point is mapped into the virtual scene is determined based on the virtual camera and the cursor point. This can truly reflect a position that a user is going to locate in the virtual scene through the cursor point, so that the first initial editing point at which the user is going to set an object can be accurately located in the virtual scene.

Thus, through the above implementation, the first initial editing point that the user is going to set an object can be accurately located in the virtual scene.

In this embodiment of the present disclosure, the locked range may be an axial range in the virtual scene or may be a planar range in the virtual scene. The locked range may be moved to the first initial editing point to obtain the object setting region.

For example, if a user selects the Z axis from among the X axis, the Y axis, and the Z axis as the locked range through a lock operation, since numerous Z axes may be located in the virtual scene, in order to precisely locate the object setting region that the user really needs, the Z axis may be moved to a position at which the first initial editing point is located, to obtain the object setting region. As shown in FIG. 5, an object setting region 505 is actually a Z axis that passes through the first initial editing point 504.

For another example, if a user selects the X axis and the Z axis from among the X axis, the Y axis, and the Z axis through a lock operation, a plane formed by the X axis and the Z axis is used as the locked range. Since numerous planes formed by the X axis and the Z axis may be located in the virtual scene, in order to precisely locate the object setting region that the user really needs, the plane formed by the X axis and the Z axis may be moved to a position at which the first initial editing point is located, to obtain the object setting region. That is, the object setting region is actually a plane that includes the first initial editing point and that is formed by the X axis and the Z axis.

In some feasible implementations, when the locked range is the axial range, the object setting region is determined based on a first setting direction selected from the axial range and the first initial editing point.

The axial range may be one or more of the first coordinate axis, the second coordinate axis, and the third coordinate axis in the virtual scene. If the locked range is the axial range, it means that the user is going to set a virtual object on an axis of the virtual scene.

The first setting direction may be determined through an orientation of the virtual camera. That is, the first setting direction may be the orientation of the virtual camera. For example, if the axial range is the X axis, when the orientation of the virtual camera is towards the right side, the first setting direction is a positive direction of the X axis. In a case that the orientation of the virtual camera is towards the left side, the first setting direction is a negative direction of the X axis. In a case that the orientation of the virtual camera has not been offset, the first setting direction is the positive direction of the X axis and the negative direction of the X axis.

That is, the first setting direction in the axial range is a direction in which the orientation of the virtual scene is to be mapped onto the axial range.

For example, the axial range selected by the user may be moved to the position at which the first initial editing point is located, to obtain a new axial range. Then, an axial range of the new axial range in the first setting direction matched with the orientation of the virtual camera is determined as the object setting region.

As shown in FIG. 5, if the first setting direction on the axial range is a positive direction of the Z axis, the object setting region 505 is a Z-axis range corresponding to the positive direction of the Z axis that passes through the first initial editing point 504. It should be understood that in this case, the first virtual object 202 may be limited within the Z-axis range corresponding to the positive direction of the Z axis that passes through the first initial editing point 504 for movement and drawing.

In some feasible implementations, when the locked range is the planar range, the object setting region is determined based on a second setting direction selected from the planar range and the first initial editing point.

The concept of the second setting direction is the same as the concept of the first setting direction, and reference may be made to the relevant description of the above implementation. Repeated descriptions will be omitted herein.

For example, the planar range selected by the user may be moved to the position at which the first initial editing point is located, to obtain a new planar range. Then, a planar range of the new planar range in the second setting direction matched with the orientation of the virtual camera is determined as the object setting region.

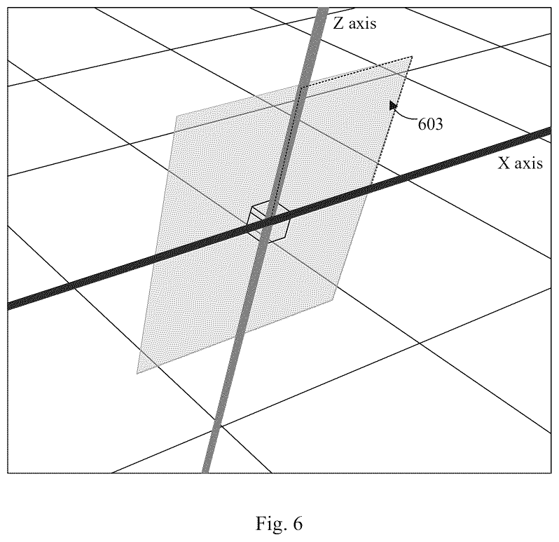

FIG. 6 is a schematic diagram of an object setting region shown according to some embodiments. As shown in FIG. 6, if the second setting direction on the planar range is a positive direction of the plane formed by the X axis and the Z axis, an object setting region 601 is a range corresponding to the positive direction of the plane that passes through the first initial editing point and that is formed by the X axis and the Z axis.

Thus, through the above implementation, the first initial editing point pointed to by the cursor point can be accurately located in a three-dimensional virtual scene, and then in conjunction with the locked range selected by the user, the object setting region that the user actually needs can be accurately and efficiently determined in the three-dimensional virtual scene, thus ensuring that the user can accurately set an object in the three-dimensional virtual scene, which greatly improves the efficiency of the user setting an object in the virtual scene.

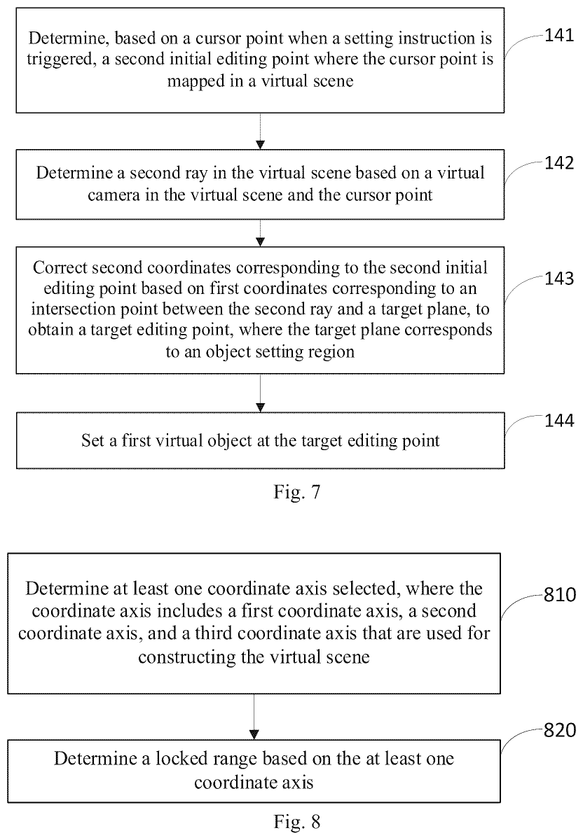

FIG. 7 is a detailed flowchart of step 140 shown in FIG. 1. As shown in FIG. 7, in some feasible implementations, step 140 may include the following steps.

In step 141, a second initial editing point where the cursor point is mapped into the virtual scene is determined based on a cursor point when the setting instruction is triggered.

The setting instruction herein may be an instruction that is triggered by a user to instruct to set the first virtual object at the target editing point in the object setting region. The second initial editing point is a point where the cursor point is mapped into the object setting region when the setting instruction is triggered. It should be noted that the cursor point is used for controlling the first virtual object to move.

It should be understood that how to determine the second initial editing point in the virtual scene may be found in the relevant description of determining the first initial editing point in the above implementation. Repeated descriptions will be omitted herein.

In step 142, a second ray in the virtual scene is determined based on the virtual camera in the virtual scene and the cursor point.

The concept of the second ray herein is consistent with the concept of the first ray, and reference may be made to the relevant description of the above implementation. Repeated descriptions will be omitted herein.

In step 143, second coordinates corresponding to the second initial editing point is corrected based on first coordinates corresponding to an intersection point between the second ray and a target plane, to obtain the target editing point, where the target plane corresponds to the object setting region.

Herein, different object setting regions may correspond to different target planes. For example, a target plane corresponding to the object setting region corresponding to the axial range is different from a target plane corresponding to the planar range.

In some embodiments, when the locked range is the axial range, a unit vector is constructed based on the first setting direction selected from the axial range and the second initial editing point; and the target plane corresponding to the axial range is determined based on the unit vector and a plane in which the virtual camera in the virtual scene is located.

Detailed descriptions of both the first setting direction and the second initial editing point may be found in the relevant description of the above implementation. The unit vector is a vector constructed by using the second initial editing point as an origin and the first setting direction as a vector direction. Then, the plane in which the virtual camera is located is moved onto the unit vector, to obtain a plane P that contains the unit vector. The plane P is the target plane.

It is worth noting that because the target plane is determined based on the plane, in which the virtual camera is located, in the virtual scene, when the locked range is the axial range, the target plane that meets a visual demand of a user may be located in the virtual scene.

In some other embodiments, when the locked range is the planar range, the object setting region corresponding to the planar range is the target plane.

The first coordinates where the cursor point is actually mapped onto the object setting region controlled by the user may be obtained based on the intersection point between the second ray and the target plane. Then, second coordinates corresponding to the second initial editing point are corrected based on the first coordinates, to obtain the target editing point where the cursor point is actually mapping onto the object setting region.

It should be understood that the correction performed on the second coordinates corresponding to the second initial editing point based on the first coordinates may modify a coordinate point, corresponding to the object setting region, on the second initial editing point to a value corresponding to the intersection point. For example, it is assumed that the locked range is the Y axis, the second coordinates of the second initial editing point are (3, 2, 255), and the first coordinates corresponding to the intersection point are (2, 2, 255). In this case, the target editing point is (2, 2, 255), so that the target editing point may be locked on the Y axis.

It should be understood that the second initial editing point is actually a position, pointed to by a user through the cursor point, in the virtual scene. Based on the first coordinates corresponding to the intersection point between the second ray and the target plane corresponding to the object setting region, the second coordinates corresponding to the second initial editing point are corrected, so that a range that a user sets an object may be locked within the object setting region, to ensure that the user can set an object within a specific range of a virtual space. This avoids a situation that a virtual object is set at a wrong position because of jitter of the cursor point.

In step 144, the first virtual object is set at the target editing point.

Herein, the electronic device may substantively draw a first virtual object at the target editing point, thereby setting the first virtual object at the target editing point.

Therefore, by step 141 to step 144 described above, it is possible to efficiently and accurately locate any position in the virtual scene, thereby better assisting the user in building an object in the virtual scene, which greatly enhances a gaming experience of the user.

FIG. 8 is a flowchart of determining a locked range according to an exemplary embodiment. As shown in FIG. 8, the locked range may be determined by the following steps.

In step 810, at least one coordinate axis selected is determined, where the coordinate axis includes a first coordinate axis, a second coordinate axis, and a third coordinate axis that are used for constructing the virtual scene.

Herein, the at least one coordinate axis selected by a user may be one or more of the first coordinate axis, the second coordinate axis, and the third coordinate axis in the virtual scene.

In some embodiments, the at least one coordinate axis may be determined based on a press operation for at least one selected from the group consisting of a first key corresponding to the first coordinate axis, a second key corresponding to the second coordinate axis, and a third key corresponding to the third coordinate axis.

The first key is a shortcut key corresponding to the first coordinate axis. The second key is a shortcut key corresponding to the first coordinate axis. The third key is a shortcut key corresponding to the first coordinate axis. It should be understood that the first key, the second key, and the third key may be physical keys or virtual keys.

When the electronic device has detected the press operation for at least one selected from the group consisting of the first key, the second key, and the third key, the electronic device determines the coordinate axis corresponding to the key corresponding to the press operation as the coordinate axis selected by the user.

For example, on a keyboard, the X key is the first key; the C key is the second key; and the Z key is the third key. When the user presses the X key, it indicates that the user selects the first coordinate axis as the locked range. When the user presses the X key and the C key, it indicates that the user selects the plane formed by the first coordinate axis and the second coordinate axis as the locked range. When the user presses the X key, the C key, and the Z key, it indicates that the user selects the third coordinate axis as the locked range.

It is worth noting that by determining a coordinate axis through keys, a user can quickly select a coordinate axis that needs to be locked.

In step 820, the locked range is determined based on the at least one coordinate axis.

Herein, after the user selects the at least one coordinate axis, the electronic device determines the locked range based on the at least one coordinate axis selected by the user.

In some embodiments, when the at least one coordinate axis includes any one of the first coordinate axis, the second coordinate axis, and the third coordinate axis, the locked range is determined based on the any one coordinate axis.

When the user selects any one of the first coordinate axis, the second coordinate axis, and the third coordinate axis, the any one coordinate axis selected by the user is the locked range.

For example, when the user presses the X key, it indicates that the user selects the first coordinate axis, and the first coordinate axis is used as the locked range.

In some other embodiments, when the at least one coordinate axis includes any two coordinate axes in the first coordinate axis, the second coordinate axis, and the third coordinate axis, the locked range is determined based on a planar range formed by the two coordinate axes.

When the user selects any two coordinate axes from the first coordinate axis, the second coordinate axis, and the third coordinate axis, a plane formed by the two coordinate axes selected by the user is the locked range.

For example, when the user presses the X key and the C key, it indicates that the user selects the plane formed by the first coordinate axis and the second coordinate axis as the locked range.

In still some other embodiments, when the at least one coordinate axis includes the first coordinate axis, the second coordinate axis, and the third coordinate axis, the locked range is determined based on a coordinate axis that is finally selected from the first coordinate axis, the second coordinate axis, and the third coordinate axis.

When the user selects the first coordinate axis, the second coordinate axis, and the third coordinate axis, the coordinate axis that is finally selected by the user is the locked range.

For example, when the user presses the X key, the C key, and the Z key, if a key that is finally pressed by the user is the Z key, it indicates that the user selects the third coordinate axis as the locked range.

It should be understood that if the user simultaneously presses two of the first key, the second key, and the third key, a plane formed by two coordinate axes corresponding to the two pressed keys is the locked range. If the user presses the last key again, the locked range is a coordinate axis corresponding to the last key. If the user releases one of the keys after pressing the three keys, a plane formed by coordinate axes corresponding to the remaining two keys is the locked range. If the user releases another one key, a coordinate axis corresponding to the remaining key is the locked range.

It should be understood that the locked range is determined based on the coordinate axis that is finally selected from the first coordinate axis, the second coordinate axis, and the third coordinate axis.

The user may quickly perform switching between locking within the axial range and locking within the planar range.

Thus, through the above implementation, the user can quickly select the locked range.

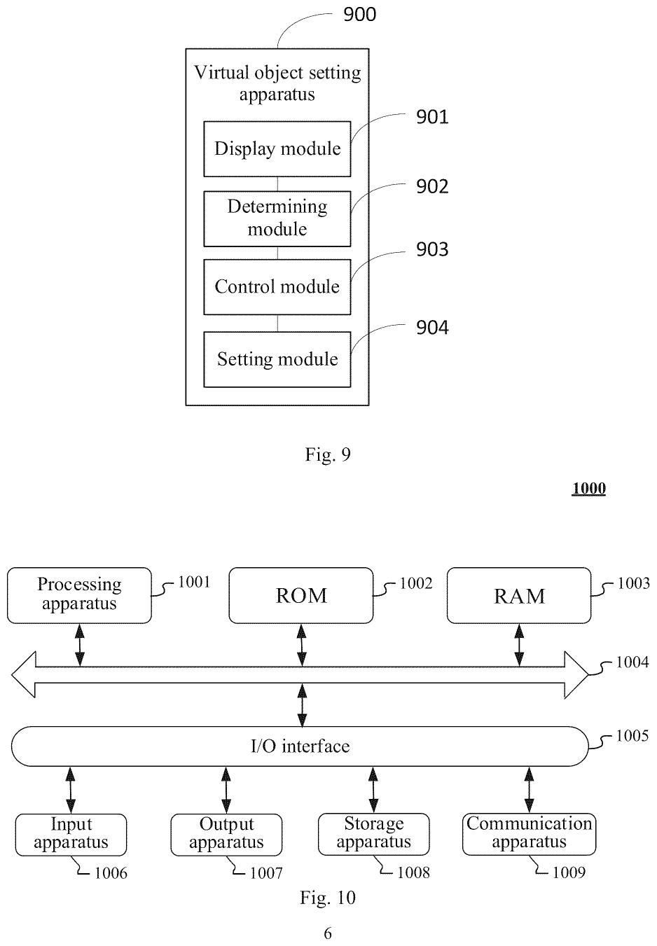

FIG. 9 is a schematic structural diagram of a virtual object setting apparatus according to some embodiments. As shown in FIG. 9, an embodiment of the present disclosure provides a virtual object setting apparatus 900. The virtual object setting apparatus 900 includes:
a display module 901 configured to display a virtual scene;
a determining module 902 configured to determine, in the virtual scene, an object setting region based on a locked range and a first initial editing point that are selected in the virtual scene, where the locked range includes an axial range and a planar range;
a control module 903 configured to control, in response to a movement operation for a first virtual object in the virtual scene, the first virtual object to move in the object setting region; and
a setting module 904 configured to set the first virtual object at a target editing point in the object setting region in response to a setting instruction.

Optionally, the virtual object setting apparatus 900 further includes:
a cursor control module configured to control, in response to switching the locked range, the cursor point to be displayed on a first virtual object to be set.

Optionally, the cursor control module is specifically configured to:
keep a position of the first virtual object to be set unchanged, and control the cursor point to move to a center point of the first virtual object to be set.

Optionally, the virtual object setting apparatus 900 further includes:
a region display module configured to display the object setting region in the virtual scene.

Optionally, the virtual object setting apparatus 900 further includes:
an object display module configured to display the first virtual object in the virtual scene in response to a scene building operation.

Optionally, the determining module 902 includes:
a point determining unit configured to determine the first initial editing point based on the cursor point displayed on the screen, where the first initial editing point is a position where the cursor point is mapped into the virtual scene.

Optionally, the point determining unit is specifically configured to:
determine a first ray in the virtual scene based on a virtual camera in the virtual scene and the cursor point; and
determine the first initial editing point based on an intersection point between the first ray and a second virtual object in the virtual scene.

Optionally, the determining module 902 includes a range determining unit. The range determining unit is configured to:
determine, when the locked range is the axial range, the object setting region based on a first setting direction selected from the axial range and the first initial editing point; and
determine, when the locked range is the planar range, the object setting region based on a second setting direction selected from the planar range and the first initial editing point.

Optionally, the setting module 904 includes:
a first determining unit configured to determine, based on a cursor point when the setting instruction is triggered, a second initial editing point where the cursor point is mapped into the virtual scene, where the cursor point is used for controlling the first virtual object to move;
a second determining unit configured to determine a second ray in the virtual scene based on the virtual camera in the virtual scene and the cursor point;
an obtaining unit configured to correct second coordinates corresponding to the second initial editing point based on first coordinates corresponding to an intersection point between the second ray and a target plane corresponding to the object setting region, to obtain the target editing point; and
a setting unit configured to set the first virtual object at the target editing point.

Optionally, the obtaining unit is specifically configured to:
construct, when the locked range is the axial range, a unit vector based on the first setting direction selected from the axial range and the second initial editing point; and
determine the target plane corresponding to the axial range based on the unit vector and a plane where the virtual camera in the virtual scene is located.

Optionally, the determining module 902 includes:
a third determining unit configured to determine at least one coordinate axis selected, where the coordinate axis includes a first coordinate axis, a second coordinate axis, and a third coordinate axis that are used for constructing the virtual scene; and
a fourth determining unit configured to determine the locked range based on the at least one coordinate axis.

Optionally, the fourth determining unit is specifically configured to:
when the at least one coordinate axis includes any one of the first coordinate axis, the second coordinate axis, and the third coordinate axis, determine the locked range based on the any one coordinate axis; when the at least one coordinate axis includes any two of the first coordinate axis, the second coordinate axis, and the third coordinate axis, determine the locked range based on a planar range formed by the any two coordinate axes; and
when that the at least one coordinate axis includes the first coordinate axis, the second coordinate axis, and the third coordinate axis, determine the locked range based on a coordinate axis that is finally selected from the first coordinate axis, the second coordinate axis, and the third coordinate axis.

Optionally, the third determining unit is specifically configured to:
determine the at least one coordinate axis based on a press operation for at least one selected from the group consisting of a first key corresponding to the first coordinate axis, a second key corresponding to the second coordinate axis, and a third key corresponding to the third coordinate axis.

The logic regarding a method performed by the functional modules in the above virtual object setting apparatus 900 may be found in the related method section in the above embodiment. Repeated descriptions will be omitted herein.

Referring to FIG. 10, FIG. 10 illustrates a schematic structural diagram of an electronic device (for example a terminal device) 1000 suitable for implementing some embodiments of the present disclosure. The terminal devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 10 is merely an example, and should not pose any limitation to the functions and the range of use of the embodiments of the present disclosure.

As illustrated in FIG. 10, the electronic device 1000 may include a processing apparatus 1001 (e.g., a central processing unit, a graphics processing unit, etc.), which may perform various suitable actions and processing according to a program stored in a read-only memory (ROM) 502 or a program loaded from a storage apparatus 1008 into a random-access memory (RAM) 1003. The RAM 1003 further stores various programs and data required for operations of the electronic device 1000. The processing apparatus 1001, the ROM 1002, and the RAM 1003 are interconnected by means of a bus 1004. An input/output (I/O) interface 1005 is also connected to the bus 1004.

Usually, the following apparatus may be connected to the I/O interface 1005: an input apparatus 1006 including, for example, a touch screen, a touch pad, a keyboard, a mouse, a camera, a microphone, an accelerometer, a gyroscope, or the like; an output apparatus 1007 including, for example, a liquid crystal display (LCD), a loudspeaker, a vibrator, or the like; a storage apparatus 1008 including, for example, a magnetic tape, a hard disk, or the like; and a communication apparatus 1009. The communication apparatus 1009 may allow the electronic device 1000 to be in wireless or wired communication with other devices to exchange data. While FIG. 10 illustrates the electronic device 1000 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 1009 and installed, or may be installed from the storage apparatus 1008, or may be installed from the ROM 1002. When the computer program is executed by the processing apparatus 1001, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the electronic device may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: displaying a virtual scene; determining, in the virtual scene, an object setting region based on a locked range and a first initial editing point that are selected in the virtual scene, where the locked range includes an axial range and a planar range; controlling, in response to a movement operation for a first virtual object in the virtual scene, the first virtual object to move within the object setting region; and setting the first virtual object at a target editing point in the object setting region in response to a setting instruction.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented in software or hardware. Among them, the name of the module does not constitute a limitation of the module itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. A virtual object setting method, comprising:
displaying a virtual scene;
determining, in the virtual scene, an object setting region based on a locked range and a first initial editing point that are selected in the virtual scene, wherein the locked range comprises an axial range and a planar range;
controlling, in response to a movement operation for a first virtual object in the virtual scene, the first virtual object to move within the object setting region; and
setting the first virtual object at a target editing point in the object setting region in response to a setting instruction.

2. The virtual object setting method according to claim 1, wherein the first initial editing point is determined by a cursor point displayed on a screen, and the virtual object setting method further comprises:
controlling, in response to switching the locked range, the cursor point to be displayed on a first virtual object to be set.

3. The virtual object setting method according to claim 2, wherein the controlling the cursor point to be displayed on a first virtual object to be set, comprises:
keeping a position of the first virtual object to be set unchanged, and controlling the cursor point to move to a center point of the first virtual object to be set.

4. The virtual object setting method according to claim 1, further comprising:
displaying the object setting region in the virtual scene.

5. The virtual object setting method according to claim 1, further comprising:
displaying the first virtual object in the virtual scene in response to a scene building operation.

6. The virtual object setting method according to claim 1, wherein the first initial editing point is determined by a following step:
determining the first initial editing point based on the cursor point displayed on the screen, wherein the first initial editing point is a position where the cursor point is mapped in the virtual scene.

7. The virtual object setting method according to claim 6, wherein the determining the first initial editing point based on the cursor point displayed on the screen, comprises:
determining a first ray in the virtual scene based on a virtual camera in the virtual scene and the cursor point; and
determining the first initial editing point based on an intersection point between the first ray and a second virtual object in the virtual scene.

8. The virtual object setting method according to claim 1, wherein the determining, in the virtual scene, an object setting region based on a locked range and a first initial editing point that are selected in the virtual scene, comprises:
determining, when the locked range is the axial range, the object setting region based on a first setting direction selected from the axial range and the first initial editing point; and
determining, when the locked range is the planar range, the object setting region based on a second setting direction selected from the planar range and the first initial editing point.

9. The virtual object setting method according to claim 1, wherein the setting the first virtual object at a target editing point in the object setting region, comprises:
determining, based on a cursor point when the setting instruction is triggered, a second initial editing point where the cursor point is mapped in the virtual scene, wherein the cursor point is used for controlling the first virtual object to move;
determining a second ray in the virtual scene based on the virtual camera in the virtual scene and the cursor point;
correcting second coordinates corresponding to the second initial editing point based on first coordinates corresponding to an intersection point between the second ray and a target plane corresponding to the object setting region, to obtain the target editing point; and
setting the first virtual object at the target editing point.

10. The virtual object setting method according to claim 9, wherein the target plane corresponding to the object setting region is determined by:
constructing, when the locked range is the axial range, a unit vector based on a first setting direction selected from the axial range and the second initial editing point; and
determining the target plane corresponding to the axial range based on the unit vector and a plane where the virtual camera in the virtual scene is located.

11. The virtual object setting method according to claim 1, wherein the locked range is determined by:
determining at least one coordinate axis that are selected, wherein the coordinate axis comprises a first coordinate axis, a second coordinate axis, and a third coordinate axis that are used for constructing the virtual scene; and
determining the locked range based on the at least one coordinate axis.

12. The virtual object setting method according to claim 11, wherein the determining the locked range based on the at least one coordinate axis, comprises:
when the at least one coordinate axis comprises any one coordinate axis selected from the group consisting of the first coordinate axis, the second coordinate axis, and the third coordinate axis, determining the locked range based on the any one coordinate axis;
when the at least one coordinate axis comprises any two coordinate axes selected from the group consisting of the first coordinate axis, the second coordinate axis, and the third coordinate axis, determining the locked range based on a planar range formed by the any two coordinate axes; and
when the at least one coordinate axis comprises the first coordinate axis, the second coordinate axis, and the third coordinate axis, determining the locked range based on a coordinate axis that is finally selected from among the first coordinate axis, the second coordinate axis, and the third coordinate axis.

13. The virtual object setting method according to claim 11, wherein the determining at least one coordinate axis that are selected, comprises:
determining the at least one coordinate axis based on a press operation for at least one selected from the group consisting of a first key corresponding to the first coordinate axis, a second key corresponding to the second coordinate axis, and a third key corresponding to the third coordinate axis.

14. (canceled)

15. A non-transitory computer-readable medium, wherein a computer program is stored on the computer-readable medium, wherein the computer program, when executed by a processing apparatus, causes a virtual object setting method to be implemented,
wherein the virtual object setting method comprises:
displaying a virtual scene;
determining, in the virtual scene, an object setting region based on a locked range and a first initial editing point that are selected in the virtual scene, wherein the locked range comprises an axial range and a planar range;
controlling, in response to a movement operation for a first virtual object in the virtual scene, the first virtual object to move within the object setting region; and
setting the first virtual object at a target editing point in the object setting region in response to a setting instruction.

16. An electronic device, comprising:
a storage apparatus, wherein a computer program is stored on the storage apparatus; and
a processing apparatus configured to execute the computer program in the storage apparatus to implement a virtual object setting method,
wherein the virtual object setting method comprises:
displaying a virtual scene;
determining, in the virtual scene, an object setting region based on a locked range and a first initial editing point that are selected in the virtual scene, wherein the locked range comprises an axial range and a planar range;
controlling, in response to a movement operation for a first virtual object in the virtual scene, the first virtual object to move within the object setting region; and
setting the first virtual object at a target editing point in the object setting region in response to a setting instruction.

17. (canceled)

18. The electronic device according to claim 16, wherein the first initial editing point is determined by a cursor point displayed on a screen, and the virtual object setting method further comprises:
controlling, in response to switching the locked range, the cursor point to be displayed on a first virtual object to be set.

19. The electronic device according to claim 18, wherein the controlling the cursor point to be displayed on the first virtual object to be set, comprises:
keeping a position of the first virtual object to be set unchanged, and controlling the cursor point to move to a center point of the first virtual object to be set.

20. The electronic device according to claim 16, further comprising:
displaying the object setting region in the virtual scene.

21. The electronic device according to claim 16, further comprising:
displaying the first virtual object in the virtual scene in response to a scene building operation.

22. The electronic device according to claim 16, wherein the first initial editing point is determined by:
determining the first initial editing point based on the cursor point displayed on the screen, wherein the first initial editing point is a position where the cursor point is mapped in the virtual scene.
